(19) United States
(12) Patent Application Publication
(10) Pub. No.: US 2011/0219868 A1
(43) Pub. Date: Sep. 15, 2011

(54) APPARATUS FOR DETECTING SNOW DEPTH

(76) Inventor: John Michael Lane, Morgan, UT (US)

(21) Appl. No.: 13/047,497

(22) Filed: Mar. 14, 2011

Related U.S. Application Data
(60) Provisional application No. 61/314,053, filed on Mar. 15, 2010.

(51) Int. Cl. G01W 1/14

(52) U.S. Cl. 73/170.21

(57) ABSTRACT

An apparatus for measuring snow depth includes a snow collector defining substantially vertically extending and opposing side walls. A plurality of light emitting devices equidistantly spaced in a substantially vertical manner is positioned along one side wall of the snow collector. A plurality of light sensors is equidistantly spaced in a substantially vertical manner along an opposite side wall of the snow collector. Each of the light sensors is optically aligned with a respective light emitting device for detecting light emitted from the light emitting device. A wireless transmitter is electronically coupled to the plurality of light sensors for transmitting signals regarding the state of the plurality of light sensors. A wireless receiver is configured for receiving the signals. A processor is programmed to receive the signals and determine and display a snow depth based on the signals.

### CROSS-REFERENCE TO RELATED APPLICATION

The present invention claims priority to U.S. Provisional Patent Application Ser. No. 61/314053, filed on Mar. 15, 2010, by John Michael Lane, entitled Apparatus for Detecting Snow Depth, the entirety of which is incorporated. by this reference.

### BACKGROUND OF THE INVENTION

1. Field of the Invention

The present invention relates generally to devices for measuring snow depth, and more specifically to a snow depth sensor that can measure in real time a depth of snow as it accumulates during a particular storm and provide real time measurements of the total snow depth.

2. State of the Art

It is often the case that ski resorts throughout the world provide daily snow totals to attract skiers to their resort. In most cases, these snow totals are determined by taking hand measurements of snow depth at the resort using a rod or measuring stick. As a result, most ski resorts only provide information regarding snow depth at the base of the mountain where the ski resort resides and where it is convenient to take such measurements. Most often, however, the ski resort will have significantly more snow at mid mountain or near the top of the mountain where various ski runs begin. Again, to provide snow depth totals at such locations, it is necessary to utilize resort personnel to travel to various locations on the mountain to take snow depth measurements.

As such, there is a need in the art to provide an accurate means of measuring snow depth at various locations at a ski resort that is automatically generated without requiring resort personnel to go to various sites around the mountain to take snow depth measurements by hand. There is also a need in the art to provide remote monitoring of various snow depth totals that can be wirelessly monitored at a single location at the ski resort. These needs are addressed by the snow depth measuring system of the present invention.

### SUMMARY OF THE INVENTION

The present invention provides an apparatus for detecting snow depth that includes a snow collector that defines substantially vertically extending and opposing side walls. A plurality of light emitting devices is attached to one side wall of the snow collector and is equidistantly spaced in a substantially vertical manner. A plurality of light sensors is equidistantly spaced in a substantially vertical manner along an opposite side wall of the snow collector with each light sensor optically aligned with a corresponding light emitting device so as to be able to detect light emitted from one of the plurality of light emitting devices. A wireless transmitter is electronically coupled to the pluralty of light sensors for transmitting signals regarding the state of the light sensors and a wireless receiver is configured for receiving the signals. A processor associated with wireless receiver is programmed to receive the signals and determine a snow depth based on the signals. The processor may be a processor in a personal computer or a monitoring device that can receive and display the snow depth based on the signals.

In another embodiment, the snow collector comprises a cylindrically shaped tube.

In still another embodiment, the snow collector comprises a bottom attached to the tube that is configured for retaining water therein.

In yet another embodiment, the first and second side walls of the snow collector each comprise vertically extending elongate members with the first and second side walls held relative to each other by support structures that interconnect the first and second side walls to maintain the first and second side walls in a substantially vertical orientation.

In yet another embodiment, a second plurality of light emitting devices is equidistantly spaced in a substantially vertical manner and interposed between the first plurality of light emitting devices and the first plurality of light sensors. A second plurality of light sensors is equidistantly spaced in a substantially vertical manner and interposed between the first plurality of light emitting devices and the first plurality of light sensors opposite the second plurality of light emitting devices. Each of the second plurality of light sensors is optically aligned with a respective one of the second plurality of light emitting devices for detecting light emitted from the respective second plurality of light emitting devices.

In still another embodiment, the second plurality of light emitting devices and second plurality of light sensors are vertically positioned between the first plurality of light emitting devices and first plurality of light sensors to provide measurements between measurements taken by the first plurality of light sensors.

In yet another embodiment, the first plurality of light emitting devices is pulsed at predetermined time intervals to conserve power.

In still another embodiment, the first plurality of light emitting devices are pulsed in senuence until a snow depth is determined by a failure of one of the first plurality of light sensors to detect light from a corresponding one of the first plurality of light emitting devices.

In another embodiment, when water is collected in the snow collector and submerges at least one light emitting device and at least one corresponding light sensor, movement of the snow collector causes the light sensor to generate a measurable square wave on an oscilloscope so that such movement can be detected.

In yet another embodiment, the wireless transmitter is coupled proximate a top of the snow collector.

The various advantages and characterizing features of a snow depth sensor according to the principles of the present invention will become apparent from the following description that discusses certain illustrative embodiments of the invention. The features and advantages of the present invention, as well as additional features and advantages, will be set forth or will become more fully apparent in the detailed description that follows and in the appended claims. The novel features which are considered characteristic of this invention are set forth in the attached claims. Furthermore, the features and advantages of the present invention may be learned by the practice of the invention, or will become more apparent to one skilled in the art from review and understanding of the description and drawings, as set forth hereinafter.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a perspective front view of a first embodiment of an apparatus for detecting snow depth in accordance with the principles of the present invention.

FIG. 2 is a perspective cross-sectional front view of the apparatus for detecting snow illustrated in FIG. 1.

FIG. 3A is a perspective, partial cross-sectional front view of the apparatus for detecting snow illustrated in FIG. 1.

FIG. 3B is a perspective, partial cross-sectional front view of a second embodiment of a snow depth sensor according to the principles of the present invention.

FIG. 4 is a circuit diagram of a for a snow depth sensor according to the principles of the present invention.

FIG. 5 is a circuit diagram of a multi-functional snow depth sensor according to the principles of the present invention.

FIG. 6 is a first oscilloscope image of a snow depth sensor according to the principles of the present invention.

FIG. 7 is a second oscilloscope image of a snow depth sensor according to the principles of the present invention.

FIG. 8 is a perspective front view of a third embodiment of an apparatus for detecting snow depth in accordance with the principles of the present invention.

FIG. 9 is a perspective front view of a plurality of snow depth sensors according to the principles of the present invention being monitored by a remote monitoring system.

FIG. 10 is a diagram illustrating measured snow depth versus actual snow depth using a snow depth measuring device according to the principles of the present invention

### DETAILED DESCRIPTION OF THE ILLUSTRATED EMBODIMENTS

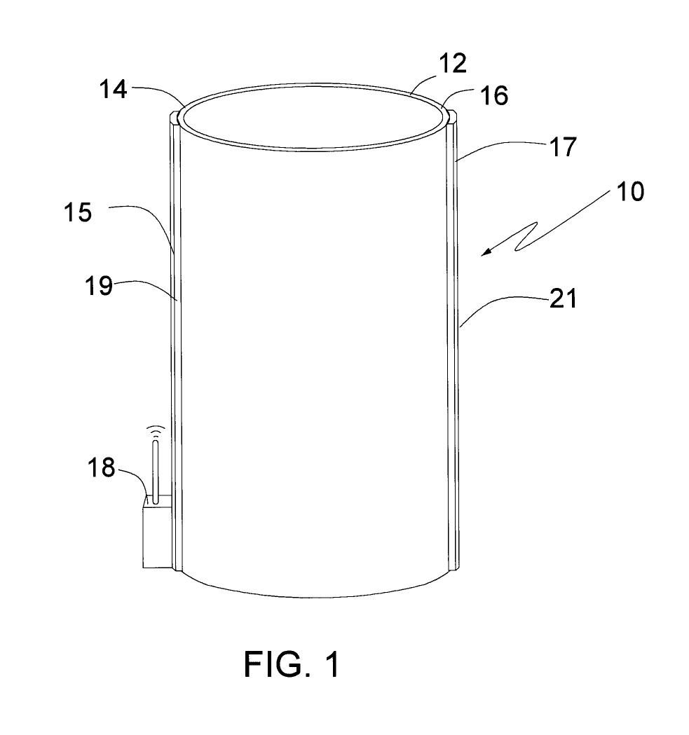

As illustrated in FIG. 1, the present invention provides a snow collecting and depth measurement apparatus, generally indicated at 10, for detecting snow depth that includes a snow collector 12 that defines substantially vertically extending and opposing side walls 14 and 16. In this case, the collector 12 is a cylindrical receptacle with the side walls 14 and 16 formed from a single, continuous wall. Laterally opposed are first and second vertically oriented arrays 15 and 17. The first array 15 includes a plurality of light emitting devices and the second array 17 includes a plurality of light sensors. Each array is disposed within elongate housings 19 and 21 within which is contained the plurality of light emitting devices and light sensors as well as electrical connections from the light emitting devices and sensors to the wireless transmitter 18. As will be described in more detail, as snow collects within the collector 12, the sensors are capable of measuring the depth of the snow within the collector 12. Data that indicates the snow depth within the collector 12 is then wirelessly transmitted via the wireless transmitting module 18 to a remote location, such as a weather station that will indicate the measured depth of snow based upon the signal received from the snow collecting and depth measurement apparatus 10.

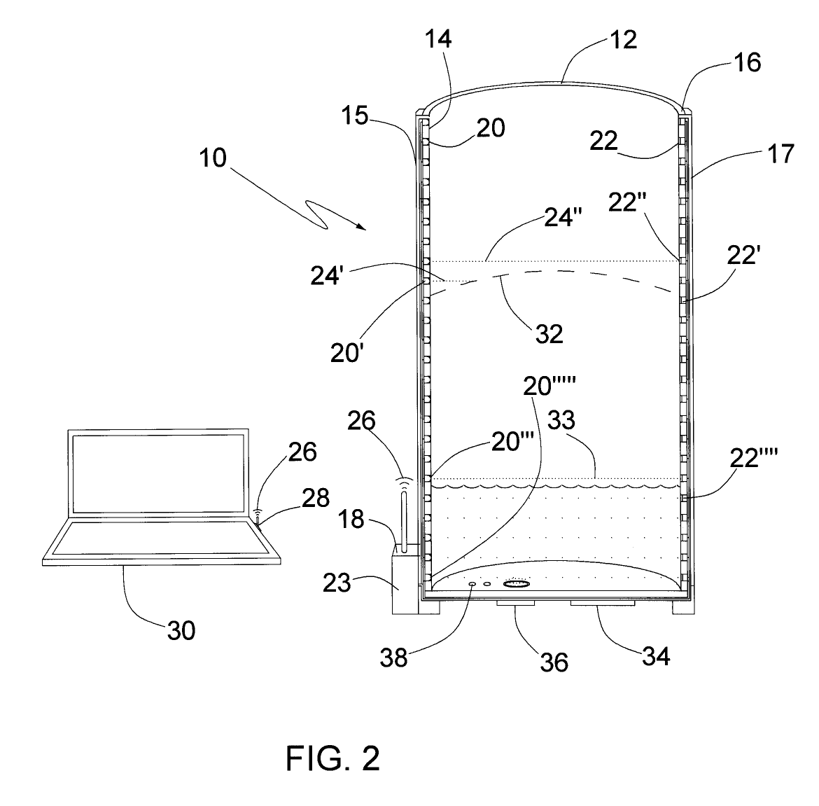

Referring now to FIG. 2, the snow depth measurement apparatus 10 of the present invention includes a pluralty of light emitting devices 20 coupled to the side wall 14 of the snow collector 12. Each light emitting device is equidistantly spaced in a substantially vertical manner. Similarly, a plurality of light sensors 22 is equidistantly spaced in a substantially vertical manner along an opposite side wall 16 of the snow collector 12 with each light sensor 22 optically aligned with a corresponding light emitting device 20 so as to be able to detect light 24 emitted from one of the light emitting devices 20. The light emitting device may be in the form of an LED or a laser light.

The light emitting devices 20 may powered by a battery pack contained within the transmitter housing 23. The battery pack may be in the form of a rechargeable battery, such as a lithium ion battery. Such battery power would also provide power for transmitting the signal 26 from the transmitter 18 and for powering the sensors 22. Likewise, the various electronic components may powered by standard line voltage by directly connecting the device to an electrical source such as a power outlet. In either case, in order to conserve power, the electrical system is intermittently powered. For example, the system can be powered on to take a reading at preset intervals (e.g., every 30 minutes) or when queried by a user from a remote location. In addition, rather than power all of the light emitting devices 20 at once, the light emitting devices may be powered starting with the bottom most light emitting device 20′″″ with each successive light emitting device 20 being powered and the previous lit light emitting device being turned off until a snow depth is detected. In other words, only one light emitting device 20 at a time needs to be lit and only for a brief moment in order to determine the snow depth. This protocol may also be reversed if it is known from a prior reading that the now depth is more likely to be closer to the top of the collector 12. As such, each light emitting device 20, beginning with the uppermost device 20, can be turned on and off in succession from top to bottom until a snow depth is measured, as indicated by a failure of the corresponding light sensor from detecting the pulsed light from a particular light emitting device 20.

As previously mentioned, the wireless transmitter 18 (e.g., RF transmitter) is electronically coupled to the plurality of light sensors 22 for transmitting signals 26 regarding the state of the light sensors 22. A wireless receiver 28 (i.e., RF receiver) is configured for receiving the signals 26. A processor associated with wireless receiver 28 is programmed to receive the signals 26 and determine a snow depth based on the signals 26. The processor may be a processor in a personal computer or other remote monitoring station 30 that can receive and display the snow depth based on the signals. Ideally, the transmitter 18 could transmit the distance from the snow depth sensor to a base station at a ski resort lodge at the base of the mountain (e.g., 3 to 5 miles).

As snow 32 accumulates in the collector 12, the snow 20 obstructs the passage of light 24′ from a light emitting device 20′ to a corresponding light sensing device 22′ positioned opposite the light emitting device 20′. The light 24″, emitted from the light emitting device 20″ to the corresponding light sensing device 22″, however, which is above the top of the snow 32, is received and detected by the corresponding light sensing device 22″. As such, all of the light sensing devices below the light sensing device 22″ will be in a state in which light from a corresponding light emitting device is not detected and all light sensing devices above the light sensing device 22″ will be triggered by light from corresponding light emitting devices. The light 24″ from the light emitting device 20″ has a beam width when it reaches a corresponding light sensor that is less than twice the distance between adjacent light sensors. That way, light from one emitter will not be detectable by more than one light sensor to prevent false readings. When using a laser, it is the case that diffraction of the light beam is less likely and thus the distance between sensors 22 can be reduced. In addition, with a laser light source, the distance between arrays 15 and 17 can be significantly increased in order to provide a very wide collector 12 that is less likely to interfere with the natural collection of snow within the collector.

As the snow 32 melts within the collector 12, resulting water 33 may be temporarily collected at the bottom of the collector 12. If desired, a heating element 34 may be provided in the collector to cause the snow to melt 32. The heating element 34 could be selectively activated by a user via the remote monitoring station. Once melted, the depth of the resulting water 33 can be measured in order to determine the water content of the snow. Light from an emitter 20′″ above the waterline will provide a light sensor reading that is greater than a light sensor reading from a light sensor 20″″ that is below the waterline. As such, even, though light in. both. sensors may be detected, the system can determine the water level given the variation between readings. When desired, an automated drain 36 that can be selectively and remotely opened and closed can be opened to allow the water 33 to drain from the collector 12. This could be triggered by a signal 26 from the monitoring station 30 through the transceiver 28 and by receiving the signal 26 at the transceiver 18 electronically coupled to the drain 26. In addition, other sensors, such as a temperature sensor 38 may be provided in the collector 12 to indicate whether the collector contains water or snow. That is, if the temperature is greater than about 32 degrees Fahrenheit, it is more likely that the collector contains water. Other ambient temperature sensors may be provided to provide real time outside temperature readings at the location of the snow depth sensor 10.

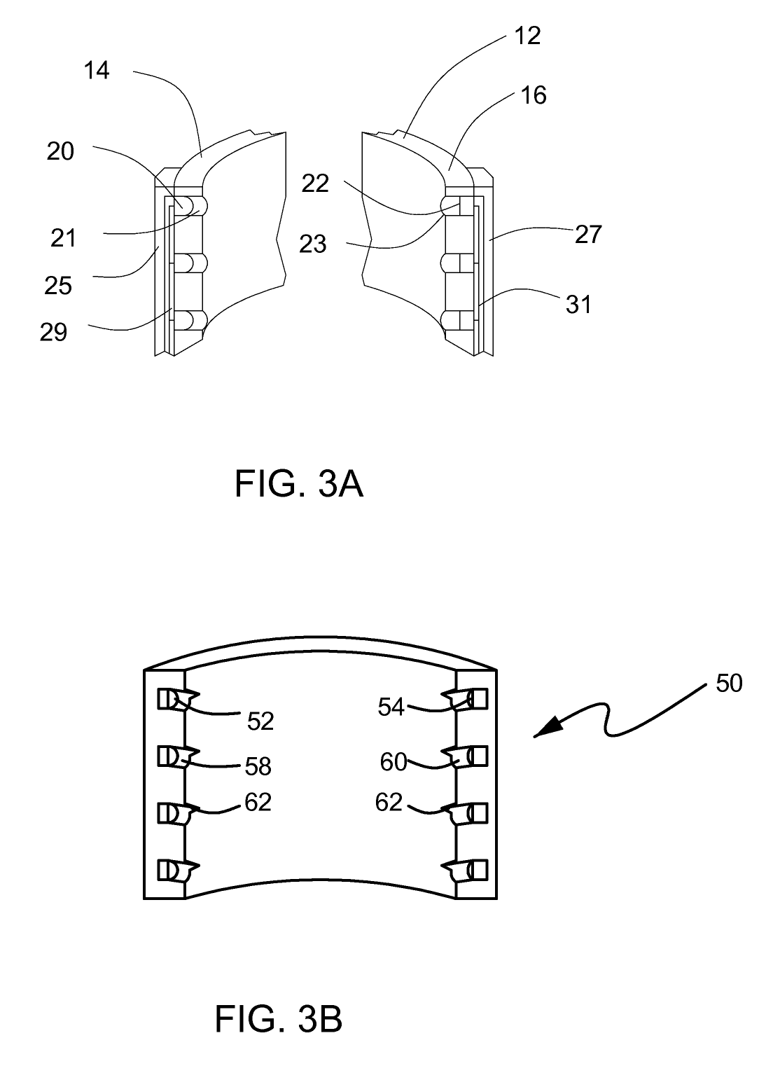

As shown in FIG. 3A, the light emitting devices 20 and light receiving devices 22 are positioned within holes 21 and 23 in the side walls 14 and 16, respectively, of the collector 12. Each lens of the emitter 20 and sensor 22 are recessed within a respective hole 21 and 23 so as to minimize light dispersion from an emitter 20 and unintended light, such as light from an adjacent emitter or natural sunlight (e.g., radiation, interference of 700 nm-1400 nm for infrared-A type) from providing a false reading of the sensor 22. The emitter 20 and sensor 22 may comprise a photo-transistor pair that is hard wired as set forth herein. Each emitter 20 and sensor 22 is sealed within its respective hole 21 and 23 so as to form a water-tight seal between the emitter 20 and sensor 22 and the walls 14 and 16 of the collector. As such, water cannot pass between the emitter 20 or sensor 22 and the interior wall of the collector 12 in order to maintain the integrity of the electrical circuitry of the snow depth measuring device.

A pair of elongate covers 25 and 27 is provided along the outside surface of the collector 12 and each longitudinally extend over the back sides of the emitters 20 and sensors 22. The covers 25 and 27 are attached to the outside of the collector 12 in a water-tight manner to prevent moisture from affecting the integrity of the electronic components of the collector 12. The wires 29 and 31 of the emitters 20 and sensors 22 are encapsulated by the covers 25 and 27, respectively.

Each photo-transistor pair are spaced a distance from an adjacent pair. For measuring snow at a ski resort, for example, it may only be necessary or desired to provide the total number of inches of snow. In such a case, the pairs can be equally spaced at one inch increments to provide snow depth totals in whole inches. Each element, whether it be an emitter 20 or a sensor 22 is positioned within a respective hole 21 and 23 of the collector and provided with a waterproof adhesive/sealant between the element and the hole to provide a water-tight seal. This prevents water from leaking from the collector through the holes 21 and 23 and prevents water damage of the electrical components of the collector that could result in short circuiting.

FIG. 3B illustrates another embodiment of a snow depth measuring device, generally indicated at 50 in accordance with the principles of the present invention. In order to protect the light emitting devices 52 and light sensors 54 from being damaged due to freezing water, each corresponding recess 58 and 60, respectively, within which the light emitting devices 52 and sensors 54 reside, is downwardly angled so as to cause any water that may accumulate therein, as from melting snow, will gravity drain from the openings 58 and 60. In addition, above each light emitting device 52 and each sensor 54 is an inwardly projecting visor 62 above each opening 58 and 60. The visors 62 prevent incident ambient light from falsely triggering one of the sensors 54 and also keeps falling snow or other precipitation from collecting within the openings 58 and 60.

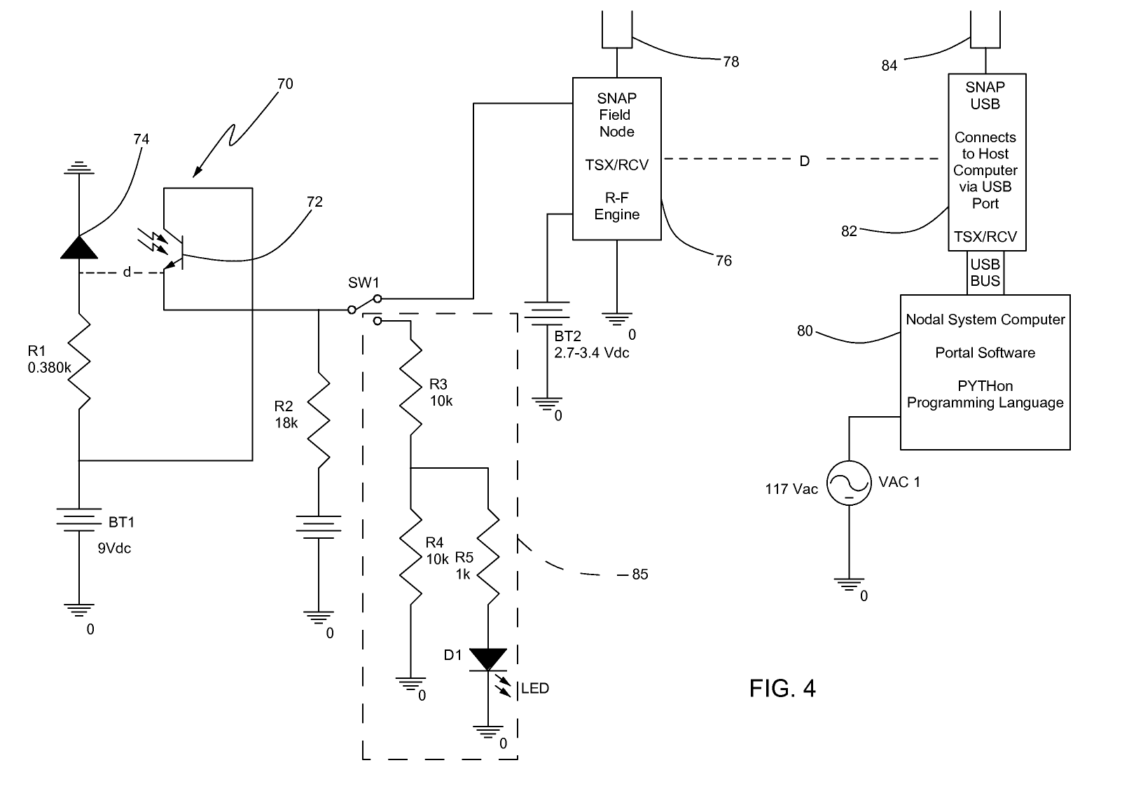

Referring now to FIG. 4, there is illustrated a circuit diagram for the now depth sensor according to the principles of the present invention. The sensor includes photo-transistor pairs that are wired in a common collector configuration. SMD passives, scaled for 9Vdc, are used for a voltage divider. SMD LED and current limiting passives are also provided as well as a battery such as a 9 volt DC battery. With the circuit connected to the voltage source, the SMD LED illuminates. When snow accumulates to a depth that is above the LED, the LED turns off. When the snow is melted, it closes the photo pair and the LED illuminates again.

Each photo pair 70 comprises one sensor unit. The distance “d” between the light sensor 72 and the LED 74 can be any distance, up to about three feet or more. The sensor unit 70 is electronically coupled to a field node 76 that includes a transceiver and RF engine for transmitting data corresponding to the state of the sensor units 70 of a snow depth sensor to a remote nodal system computer 80. The field node 76 includes a node antenna 78 to transmit the sensor data.

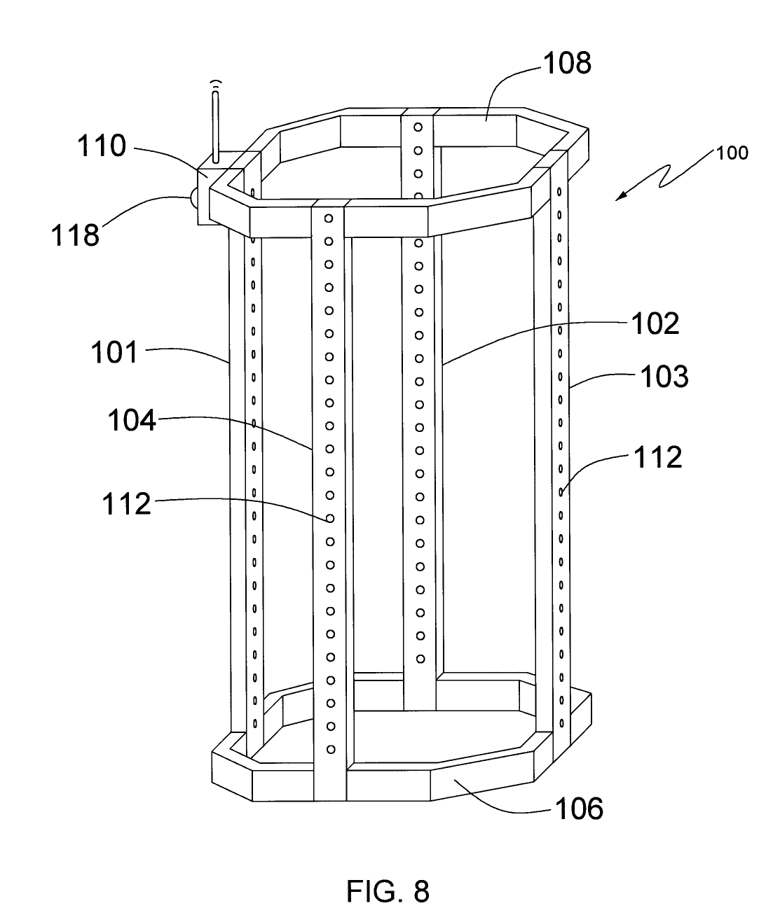

A switch SW1 is provided between the photo pair 70 and the field node 76. When the switch SW1 is positioned as shown in FIG. 4, the field node 76 is electrically connected to the photo pair 70. In order to test and verify that the photo pair 70 is functioning properly, a manual sensor test circuit 85 is provided. The manual sensor test circuit 85 provides an LED D1 that can be electrically connected to the field node 76 through switch SW1. When connected, if the field node 70 is functioning properly, the LED D1 will illuminate if the sensor 72 is receiving light from the light source 74. The test circuit 85 can be incorporated into the snow depth sensor of the present invention, as is described in more detail with reference to FIG. 8 (see LED 112 and switch 118).

Coupled to the nodal system computer 80 is a USE transceiver 82. The USB transceiver receives signals from the node antenna 78 through the wireless network antenna 84 and, via the USE bus of the computer 80 provides this data to the computer for processing. The computer 80 includes portal software that converts the data into a snow depth measuring reading in inches or other standard measure. The portal software may be programmed in PYTHon programming language. In addition, the nodal communication protocols used by the system may employ SNAP nodal protocols so, as will be described in more detail, a plurality of snow depth measuring devices can be simultaneously monitored by the nodal system computer 80.

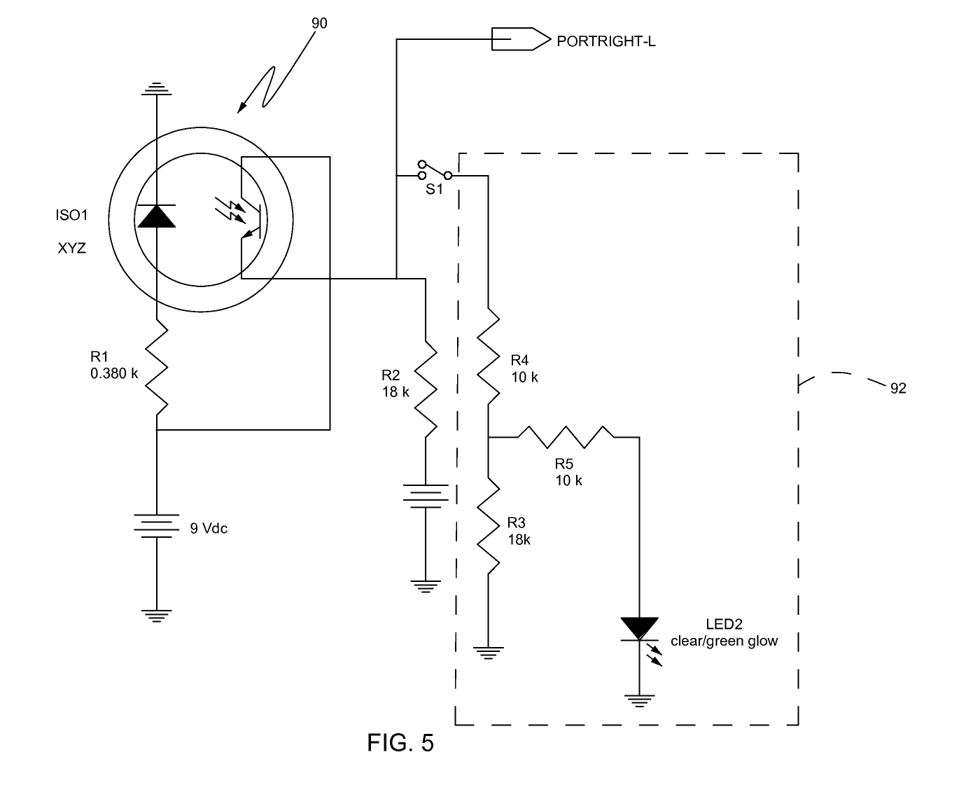

In addition to the snow depth total reading as provided by the photo-transistor pairs, the present invention is also capable of detecting movement of the snow depth sensor when it contains a quantity of water sufficient to have at least one pair of photo-transistor pairs submerged. The circuit diagram illustrated in FIG. 5 shows such a multi-functional snow depth sensor. The sensor 90 is capable of detecting liquid vibrations by generating square wave oscillations, when measured with an oscilloscope. The sensor 90 is coupled to a test point output, labeled as PORTRIGHT-L that is connected to the transceiver of the system, such as has been previously described herein. With such a system, when the electrical circuit of the snow depth sensor is coupled to an oscilloscope, movement of the snow depth sensor can be detected.

Similar to the test circuit 85 illustrated in FIG. 4, a manual test circuit 92 is provided between the sensor 90 and the test point output. When the switch 61 is closed, the operation of the sensor 90 can be tested and verified in order to test and verify that the sensor 90 is functioning properly. The manual sensor test circuit 92 provides an LED, labeled as LED2, that can be electrically connected to the sensor 90 through switch S1. When connected, if the sensor 90 is functioning properly, the LED will illuminate.

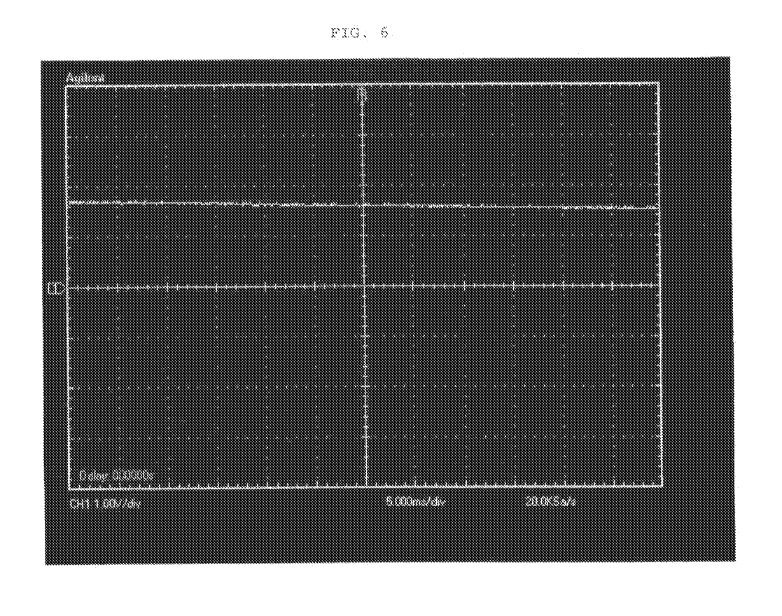

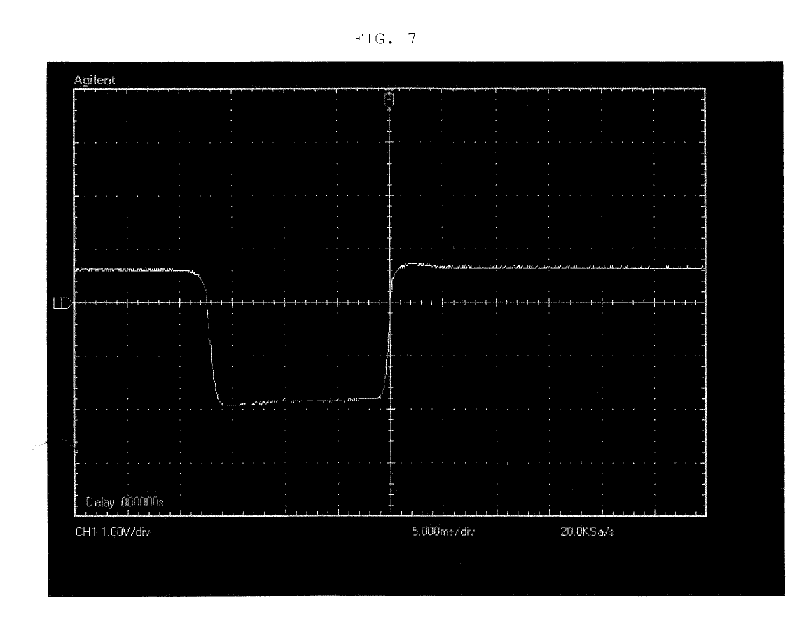

As shown in FIG. 6, when there is a detectable level of snow present in the collector, a substantially constant reading is obtained. As shown in FIG. 7, however, when the snow depth sensor, is tripped by movement, a square wave of the oscillator indicates motion by a change in the oscilloscope image. Accordingly, the snow depth sensor according to the present invention is also capable of detecting movement.

Referring now to FIG. 8, there is illustrated an alternate embodiment of a snow depth sensor, generally indicated at 100, in accordance with the principles of the present invention. Rather than having the collector be comprised of a solid tube (as shown in FIG. 1), the sensor is comprised of four vertical sensor arrays 101-104. A lower ring-like support base 106 is connected to and between the bottom ends of the sensor arrays for supporting the sensor arrays 101-104 in an upright manner and an upper ring-like support 108 is coupled to and between the upper ends of the sensor arrays 101-104 to maintain the lateral spacing between the upper ends of the sensor arrays 101-104 as well as provide structural support for the sensor 100.

The interconnecting wiring for each of the senor arrays 101-104 is housed within the upper support 108. This reduces the possibility of water damage to the electrical circuitry of the device 100 in the field. Likewise, the transceiver 110 for the device 100 is coupled to the upper end of one of the sensor arrays 101. In this way, the accumulation of snow is less likely to interfere with signal transmission to and from the transceiver 110. The sensor arrays 101-104 are arranged in pairs with the sensor arrays 101 and 103 comprising one set of sensor pairs and the sensor arrays 102 and 104 forming a second set of sensor pairs. Thus, the sensor array 101 includes a plurality of light emitting devices and the sensor array 103 includes a plurality of light sensors. Likewise, the sensor array 102 includes a plurality of light emitting devices and the sensor array 104 includes a plurality of light sensors. By including two sets of sensor pairs, more finite measurements can be taken by having the second set of sensor pairs offset from the first set. For example, if adjacent sensors of one array are spaced one inch apart, the pair of sensors would detect snow depth in one inch increments. By including a second pair of sensor arrays that are vertically offset by ½ inch from the first pair of sensor arrays, the combination of sensors can then measure snow depth in half inch increments. In addition, by having two pairs of sensor arrays, the readings from the two pairs of sensor arrays can be compared to determine, if there is an error in the readings of one of the sensor pairs. For example, if a one sensor pair measures a snow depth of 3 inches and the other sensor pair measures a snow depth of 2½ inches, it is likely that the sensor pair at two inches has malfunctioned and in need possible need of repair. In order to provide an on-site verification that the sensor array is accurately measuring the snow depth, external LEDs 112 can be coupled to the back sides of the sensor arrays 103 and 104. A button 118 is provided on the transceiver housing 110 that, when depressed, causes each LED associated with an untripped sensor to illuminate. If the LEDs above the snow illuminate and the ones below the snow level do not, the device 100 is functioning properly.

The open sided construction of the sensor 100 of also has the advantage that it is less likely to interfere with the accumulation of snow in and around each sensor array 101-104. Thus, even sideways blowing snow can accumulate between the sensor arrays 101-104 in its natural state.

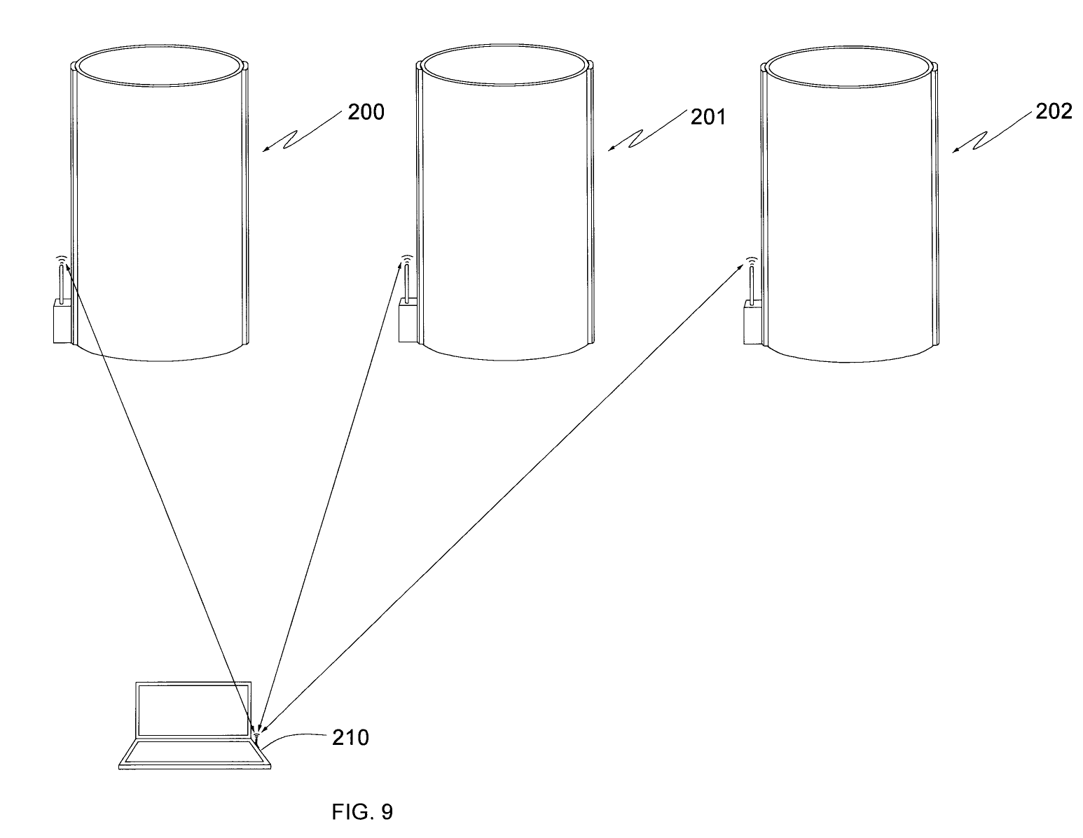

As shown in FIG. 9, a plurality of snow depth sensors 200, 201 and 202 are simultaneously monitored by a remote monitoring system 210. Each sensor 200, 201 and 202 can be positioned, for example, at various locations and elevations around a ski resort. Readings for each of the snow sensors are transmitted to the monitoring system. These readings are then processed and displayed as snow depth for each sensor 200-202. The redundancy of sensors also provides a means for determining accuracy of measurement. For example, if sensors 200 and 201 are positioned at a similar elevation, when the mountain is known to have similar snow depths, a widely varying reading between the sensors 200 and 201 may indicate that one of the sensors is providing a false reading and can be inspected for possible repair.

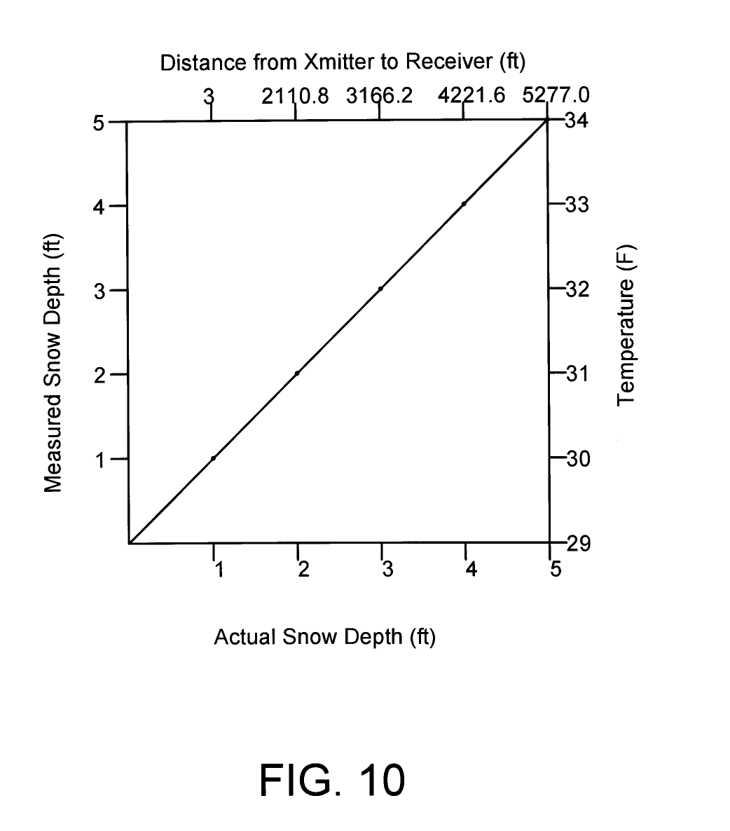

Referring now to FIG. 10, there is illustrated a graph that depicts snow depth measurements taken by a snow depth sensor according to the present invention from one to five inches at one foot increments. As shown, the measured and actual snow depths in feet provided a one to one correlation with no difference measurable difference between the measured snow depth and actual snow depth. In addition, there was no effect on the measurements due to a change in ambient temperatures between 29 and 34 degrees Fahrenheit. In addition, there was no effect on the measurements due to a change in distance between the snow depth sensor and the monitoring unit from between 3 feet and approximately one mile (5277 feet). As such, the snow depth measuring device of the present invention has been tested and proven to provide accurate snow depth measurements in the field regardless of transmission distance or ambient temperature.

While there have been described various embodiments of the present invention, those skilled in the art will recognize that other and further changes, modifications and combinations of the various embodiments may be made thereto without departing from the spirit or scope of the invention, and it is hereby intended to claim all such changes and modifications that fall within the true scope of the invention. It is also understood that, as used herein and in the appended claims, the singular forms “a,” “an,” and the include plural reference, unless the context clearly dictates otherwise.

Unless defined otherwise, all technical and scientific to used herein have the same meanings as commonly understood by one of ordinary skill in the art to which this invention belongs. While various methods and structures of the present invention are described herein, any methods or structures similar or equivalent to those described herein may by used in the practice or testing of the present invention. All references cited herein are incorporated by reference in their entirety and for all purposes. In addition, while the foregoing advantages of the present invention are manifested in the illustrated embodiments of the invention, a variety of changes can be made to the configuration, design and construction of the invention to achieve those advantages including combinations of components of the various embodiments. Hence, reference herein to specific details of the structure and function of the present invention is by way of example only and not by way of limitation.

What is claimed is:

1. An apparatus for detecting snow depth, comprising:
a snow collector defining substantially vertically extending and opposing side walls;
a first plurality of light emitting devices equidistantly spaced in a substantially vertical manner along a first side wall of the snow collector;
a first plurality of light sensors equidistantly spaced in a substantially vertical manner along a second opposite side wall of the snow collector, each of said light sensors optically aligned with a respective one of said plurality of light emitting devices for detecting light emitted from said respective one of said plurality of light emitting devices;
a wireless transmitter electronically coupled to said plurality of light sensors for transmitting signals regarding the state of said plurality of light sensors;
a wireless receiver configured for receiving the signals; and
a processor programmed to receive the signals and determine a snow depth based on the signals.

2. The apparatus of claim 1, wherein the snow collector comprises a cylindrically shaped tube.

3. The apparatus of claim 2, wherein the snow collector comprises a bottom attached to the tube and configured for retaining water therein.

4. The apparatus of claim 1, wherein the first and second side walls each comprise vertically extending elongate members with the first and second side walls held relative to each other by support structures that interconnect the first and second side walls to maintain the first and second side walls in a substantially vertical orientation.

5. The apparatus of claim 1, further comprising a second plurality of light emitting devices equidistantly spaced in a substantially vertical manner interposed between said first plurality of light emitting devices and said first plurality of light sensors and a second plurality of light sensors equidistantly spaced in a substantially vertical manner interposed between said first plurality of light emitting devices and said first plurality of light sensors and opposite said second plurality of light emitting devices, each of said second plurality of light sensors optically aligned with a respective one of said second plurality of light emitting devices for detecting light emitted from said respective one of said second plurality of light emitting devices.

6. The apparatus of claim 5, wherein the second plurality of light emitting devices and second plurality of light sensors are vertically positioned between the first plurality of light emitting devices and first plurality of light sensors to provide measurements between measurements taken by the first plurality of light sensors.

7. The apparatus of claim 1, wherein the first plurality of light emitting devices is pulsed at predetermined time intervals to conserve power.

8. The apparatus of claim 7, wherein the first plurality of light emitting devices are pulsed in sequence until a snow depth is determined by a failure of one of the first plurality of light sensors to detect light from a corresponding one of the first plurality of light emitting devices.

9. The apparatus of claim 3, wherein when water is collected in the snow collector that submerges at least one light emitting device and at least one corresponding light sensor, movement of the snow collector causes the light sensor to generate a measurable square wave on an oscilloscope so that such movement can be detected.

10. The apparatus of claim 1, wherein the wireless transmitter is coupled proximate a top of the snow collector.

11. A system for simultaneous remote detecting of snow depth at various locations, comprising:
a plurality of snow depth measuring devices, each configured to be positioned at a different location and each comprising:
a first sensor array comprising a first plurality of vertically spaced light emitting devices;
a second sensor array comprising a first plurality of vertically spaced light sensors, the second sensor array spaced from said first sensor array with the plurality of light sensors facing the plurality of light emitting devices with each light emitting device substantially horizontally aligned with a respective light sensor of the plurality of light sensors; and
a wireless transmitter electronically coupled to said plurality of light sensors for transmitting signals regarding a state of at least one of the plurality of light sensors; and
a remote monitoring system comprising:
a wireless receiver configured for receiving the signals from each of the plurality of snow depth measuring devices; and
a processor programmed to receive the signals and determine a snow depth based on the signals at each of the plurality of snow depth measuring devices.

12. The system of claim 11, wherein each of the plurality of snow depth detection devices comprises a cylindrically shaped tube.

13. The system of claim 12, wherein each of the plurality of snow depth detection devices comprises a bottom attached to the tube and configured for retaining water therein.

14. The system of claim 11, wherein the first and second sensor arrays comprise vertically extending elongate members held relative to each other by support structures that interconnect the elongate members to maintain the first and second sensor arrays in a substantially vertical orientation.

15. The system of claim 11, further comprising a third sensor array having a second plurality of light emitting devices equidistantly spaced in a substantially vertical manner interposed between said first plurality of light emitting devices and said first plurality of light sensors and a fourth sensor array having a second plurality of light sensors equidistantly spaced in a substantially vertical manner interposed between said first plurality of light emitting devices and said first plurality of light sensors and opposite said second plurality of light emitting devices, each of said second plurality of light sensors optically aligned with a respective one of said second plurality of light emitting devices for detecting light emitted from said respective one of said second plurality of light emitting devices.

16. The system of claim 15, wherein the second plurality of light emitting devices and second plurality of light sensors are vertically positioned between the first plurality of light emitting devices and first plurality of light sensors to provide measurements between measurements taken by the first plurality of light sensors.

17. The system of claim 11, wherein the first plurality of light emitting devices is pulsed at predetermined time intervals to conserve power.

18. The system of claim 17, wherein the first plurality of light emitting devices are pulsed in sequence until a snow depth is determined by a failure of one of the first plurality of light sensors to detect light from a corresponding one of the first plurality of light emitting devices.

19. The apparatus of claim 13, wherein when water is collected in the snow depth detection device and submerges at least one light emitting device and at least one corresponding light sensor, movement of the snow depth detection device causes the light sensor to generate a measurable square wave on an oscilloscope so that such movement can be detected.

20. The apparatus of claim 11, wherein the wireless transmitter is coupled proximate a top of the snow depth detection device.
